(19) United States
(12) Patent Application Publication
(10) Pub. No.: US 2006/0220994 A1
(43) Pub. Date: Oct. 5, 2006

(54) PLASMA DISPLAY DEVICE AND METHOD FOR DRIVING THE SAME

(75) Inventors: Akihiro TAKAGI, Kawaguchi (JP); Takashi Sasaki, Hiratsuka (JP); Akira Otsuka, Zama (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki-shi (JP)

(21) Appl. No.: 11/277,593

(22) Filed: Mar. 27, 2006

(30) Foreign Application Priority Data
Mar. 29, 2005 (JP) 2005-094303

(51) Int. Cl. G09G 3/28

(52) U.S. Cl. 345/60

(57) ABSTRACT

A plasma display device capable of stably generating a discharge between an address electrode and a scan electrode without being influence by temperature in an address period is provided. The plasma display device having a temperature detecting part that detects temperature, a scan electrode to which a scan pulse for selection is applied in the address period, an address electrode to which an address pulse is applied corresponding to the scan pulse to select emission or non-emission of a display cell, and a scan electrode drive circuit which supplies a voltage to the scan electrode in accordance with the detected temperature is provided. The scan electrode dive circuit changes a voltage of the scan electrode at a time of not applying the scan pulse in the address period in accordance with the detected temperature without changing an amplitude of the scan pulse.

### CROSS-REFERENCE TO RELATED APPLICATIONS

This application is based upon and claims the benefit of priority from the prior Japanese Patent Application No. 2005-094303, filed on Mar. 29, 2005, the entire contents of which are incorporated herein by reference.

### BACKGROUND OF THE INVENTION

1. Field of the Invention

The present invention relates to a plasma display device and a method for driving the same.

2. Description of the Related Art

FIG. 4 is a timing chart showing an operation example of one field of a plasma display device, and FIG. 6 is a circuit diagram showing a configuration example of a Y drive circuit of the plasma display device. The Y drive circuit in FIG. 6 generates a voltage of a scan electrode (hereinafter called a Y electrode) Y1. A circuit which generates a Y electrode Y2 has the same configuration. A panel capacitance Cp is constructed by, for example, an X electrode X1 and the Y electrode Y1. In a reset period Tr, reset of a display cell is performed by a reset pulse. The voltages of the Y electrodes Y1 and Y2 are generated by voltages Vs, Vp and −Vn. In a first half address period Ta1, address selection of an odd-numbered Y electrode Y1 is performed. In a second half address period Ta2, address selection of an even-numbered Y electrode Y2 is performed. The details of the address periods Ta1 and Ta2 will be described later with reference to FIG. 7. In a sustain period Ts, sustain pulses are applied to the Y electrodes Y1 and Y2. The sustain pulse is generated by the positive voltage Vs and ground GND. By this sustain pulse, sustain discharge can be performed between the X electrode X1 and the Y electrode Y1, and between the X electrode X2 and the Y electrode Y2.

FIG. 7 is a timing chart for explaining a method for generating a voltage of a Y electrode Y in the address periods Ta1 and Ta2. The Y electrode Y corresponds to the Y electrode Y1 or Y2.

Before a timing t1, switches SW1, SW3, SW5, SW6, SW7, SW9, SW10 and SW11 are turned off, and switches SW2, SW4, SW8, SW12 and SW13 are turned on. Then, the Y electrode Y is at zero V (ground GND).

Next, at the timing t1, the switches SW2, SW4, SW8 and SW12 are turned off, and the switches SW7, SW9 and SW10 are turned on. Then, the Y electrode Y is at a voltage −V2.

Next, at a timing t2, the switch SW 10 is turned off, and the switch SW11 is turned on. Then, the Y electrode Y is at a voltage −V1. The pulse of this voltage −V1 is a scan pulse. An amplitude voltage V3 of the scan pulse is V1-V2. When an address pulse of voltage V4 is applied to an address electrode A at a time of applying the scan pulse, a discharge is generated between the Y electrode Y and the address electrode A, and lighting of the display cell constructed by the Y electrode Y is selected.

Next, at a timing t3, the switch SW10 is turned on, and the switch SW 11 is turned off. Then, the Y electrode Y is at a voltage −V2.

Next, at a timing t4, the switches SW2, SW4, SW8 and SW12 are turned on, and the switches SW7, SW9 and SW10 are turned off. Then, the Y electrode Y has 0V.

As described above, in the address periods t1 to t4, the Y electrode Y is at the scan voltage −V1 at the time of applying the scan pulse, and is at the non-scan voltage −V2 when the scan pulse is not applied.

FIG. 5 is a timing chart showing an operation example of one field of another plasma display device, and FIG. 8 is a circuit diagram showing a configuration example of a Y drive circuit of the plasma display device. The Y drive circuit in FIG. 8 generates the voltage of the Y electrode Y1. The circuit which generates the Y electrode Y2 has the same configuration. The panel capacitance Cp is constructed by, for example, the X electrode X1 and the Y electrode Y1. In the reset period Tr, reset of a display cell is performed by a reset pulse. The voltages of the Y electrodes Y1 and Y2 are generated by the voltages Vs, Vp and −Vs. In the first half address period Ta1, address selection of the odd-numbered Y electrode Y1 is performed. In the second half address period Ta2, address selection of the even-numbered Y electrode Y2 is performed. The details of the address periods Ta1 and Ta2 will be described later with reference to FIG. 9. In the sustain period Ts, sustain pulses are applied to the Y electrodes Y1 and Y2. The sustain pulse is generated by the positive voltage Vs and a negative voltage −Vs. By this sustain pulse, a sustain discharge can be performed between the X electrode X1 and the Y electrode Y1, and between the X electrode X2 and the Y electrode Y2.

FIG. 9 is a timing chart for explaining a method for generating a voltage of a Y electrode Y in the address periods Ta1 and Ta2. The Y electrode Y corresponds to the Y electrode Y1 or Y2.

Before the timing t1, the switches SW1, SW 2, SW3, SW4, SW5 and SW7 are turned off, and the switches SW6, SW8 and SW9 are turned on. Then, the Y electrode Y is at zero V.

Next, at the timing t1, the switches SW4 and SW5 are turned on, and the switches SW6, SW8 and SW9 are turned off. Then, the Y electrode Y is at the voltage −V2.

Next, at the timing t2, the switch SW5 is turned off, and the switch SW6 is turned on. Then, the Y electrode Y is at the voltage −V1. The pulse of this voltage −V1 is a scan pulse. An amplitude voltage Vs of the scan pulse is V1-V2. When an address pulse of a voltage V4 is applied to the address electrode A at a time of applying the scan pulse, a discharge is generated between the Y electrode Y and the address electrode A, and lighting of the display cell constructed by the Y electrode Y is selected.

Next, at the timing t3, the switch SW5 is turned on, and the switch SW6 is turned off. Then, the Y electrode Y is at the voltage −V2.

Next, at the timing t4, the switches SW4 and SW5 are turned off, and the switches SW6, SW8 and SW9 are turned on. Then, the Y electrode Y has 0V.

As described above, in the address periods t1 to t4, the Y electrode Y is at the scan voltage −V1 at the time of applying the scan pulse, and is at the non-scan voltage −V2 when the scan pulse is not applied.

Japanese Patent Application Laid-open No. 2002-297090 discloses a driving method and a driving apparatus for a plasma display panel which realize addressing less influenced by a change in the operating environment and stabilize display.

FIG. 10 is a diagram showing the voltage waveform of the Y electrode Y1 in the first (uppermost) line and an address electrode in the address periods Ta1 and Ta2, and FIG. 11 is a diagram showing the voltage waveform of a Y electrode Yn in the final (lowermost) line and the address electrode A in the address periods Ta1 and Ta2. The scan pulse at the voltage −V1 is sequentially applied to the Y electrodes Y1, Y2, . . . , and Yn. A two-dimensional image is constructed by a plurality of lines. The Y electrode Y1 is the Y electrode in the first line, and a scan pulse is applied thereto first. The Y electrode Yn is the Y electrode in the final line, and the scan pulse is applied thereto at last.

In FIG. 10, positive wall charges are accumulated on the address electrode A by the reset pulse in the reset period Ts before the address periods Ta1 and Ta2. Thereby, when a scan pulse is applied to the Y electrode Y1 in the first line, a discharge can be generated between the Y electrode Y1 and the address electrode A even if the address electrode A is at the low address voltage V4. Here, the address voltage V4 is always applied to the address electrode A during address period, and the address electrode A generates discharge with all the Y electrodes Y1 to Yn. For example, this is the case where all the pixels in the vertical direction are displayed.

In FIG. 11, a potential difference V4+V2 is always applied to the Y electrode Yn in the final line between itself and the address electrode A until a scan pulse is applied to the Y electrode Yn. Therefore, especially at a time of high temperature, very small positive charge shift to the Y electrode Yn from the address electrode A occurs, and when the scan pulse is applied to the Y electrode Yn, the positive wall charge on the address electrode A which are required for the discharge between the address electrode A and the Y electrode Yn decreases, and a discharge cannot be generated between the address electrode A and the Y electrode Yn. In this situation, address selection is not performed, and the final line is not displayed.

### SUMMARY OF THE INVENTION

An object of the present invention is to provide a plasma display device and a method for driving the same, which can generate a discharge between an address electrode and a scan electrode stably without being influenced by temperature in an address period.

According to one aspect of the present invention, a plasma display device having a temperature detecting part that detects temperature, a scan electrode to which a scan pulse for selection is applied in an address period, an address electrode to which an address pulse is applied corresponding to the scan pulse to select emission or non-emission of a display cell, and a scan electrode drive circuit which supplies a voltage to the scan electrode in accordance with the detected temperature is provided. The scan electrode dive circuit changes the voltage of the scan electrode at a time of not applying the scan pulse in the address period in accordance with the detected temperature, without changing an amplitude of the scan pulse.

### BRIEF DESCRIPTION OF THE DRAWINGS

FIG. 1 is a diagram showing a configuration example of a plasma display device according to a first embodiment of the present invention;

FIG. 2 is an exploded perspective view showing a structure example of a plasma display panel according to the first embodiment;

FIG. 3 is a conceptual diagram showing a configuration example of each field according to the first embodiment;

FIG. 4 is a timing chart showing an operation example of one field of the plasma display device;

FIG. 5 is a timing chart showing an operation example of one field of another plasma display device;

FIG. 6 is a circuit diagram showing a configuration example of a Y drive circuit of the plasma display device;

FIG. 7 is a timing chart for explaining a generation method of a voltage of a Y electrode in an address period;

FIG. 8 is a circuit diagram showing a configuration example of the Y drive circuit of the plasma display device;

FIG. 9 is a timing chart for explaining the generation method of the voltage of the Y electrode in the address period;

FIG. 10 is a diagram showing a voltage waveform of a Y electrode in a first line and an address electrode in the address period;

FIG. 11 is a diagram showing a voltage waveform of a Y electrode in a final line and the address electrode in the address period;

FIG. 12 is a diagram showing a voltage waveform of the Y electrode in the final line and the address electrode at a time of high temperature in the address period according to the first embodiment;

FIG. 13A is a diagram showing a voltage waveform of the Y electrode in the final line and the address electrode at a time of low temperature in the address period according to the first embodiment, and FIG. 13B is a diagram showing the voltage waveform of the Y electrode in the final line and the address electrode at the time of high temperature in the address period;

FIG. 14A is a diagram showing a voltage waveform of a Y electrode in a final line and an address electrode at a time of low temperature in an address period according to a second embodiment of the present invention, FIG. 14B is a diagram showing a voltage waveform of the Y electrode in the final line and the address electrode at a time of intermediate temperature in the address period, and FIG. 14C is a diagram showing a voltage waveform of the Y electrode in the final line and the address electrode at a time of high temperature in the address period;

FIG. 15A is a diagram showing a voltage waveform example of an X electrode, a Y electrode and an address electrode of one field at a time of low temperature according to a third embodiment of the present invention, and FIG. 15B is a diagram showing a voltage waveform example of the X electrode, the Y electrode and the address electrode of one field at a time of high temperature;

FIG. 16 is a circuit diagram showing a configuration example of a Y drive circuit according to a fourth embodiment of the present invention;

FIG. 17A is a timing chart showing an operation example of the circuit in FIG. 16 at a time of low temperature in the address period, and FIG. 17B is a timing chart showing an operation example of the circuit in FIG. 16 at a time of high temperature in the address period;

FIG. 18 is a circuit diagram showing a configuration example of the Y drive circuit according to the fifth embodiment of the present invention;

FIG. 19A is a timing chart showing an operation example of the circuit in FIG. 18 at the time of low temperature in the address period, and FIG. 19B is a timing chart showing an operation example of the circuit in FIG. 18 at a time of high temperature in the address period;

FIG. 20 is a circuit diagram showing a configuration example of a Y drive circuit according to a sixth embodiment of the present invention; and

FIG. 21A is a timing chart showing an operation example of the circuit in FIG. 20 at a time of low temperature in the address period, FIG. 21B is a timing chart showing an operation example of the circuit in FIG. 20 at a time of intermediate temperature in the address period, and FIG. 21C is a timing chart showing an operation example of the circuit in FIG. 20 at a time of high temperature in the address period.

### DETAILED DESCRIPTION OF THE PREFERRED EMBODIMENTS

### First Embodiment

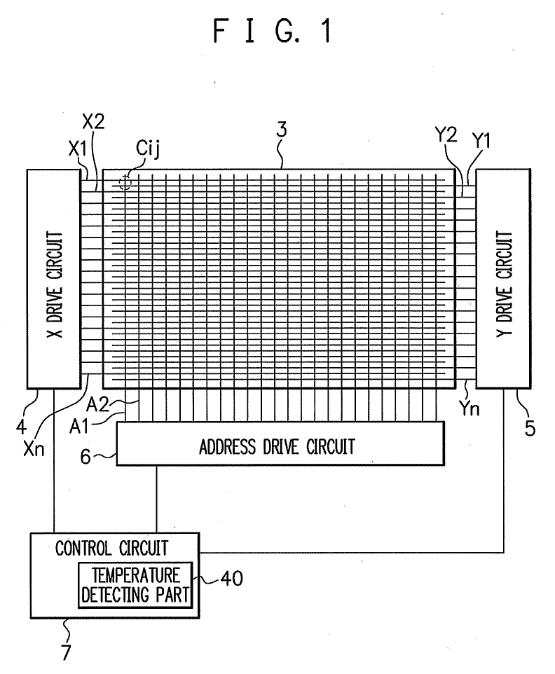

FIG. 1 is a diagram showing a configuration example of a plasma display device according to a first embodiment of the present invention. A control circuit 7 has a temperature detecting part 40, and controls an X drive circuit 4, a Y drive circuit 5 and an address drive circuit 6. The temperature detecting part 40 is, for example, a thermistor or the like, and detects temperature. The installation position and the number of the temperature detecting parts 40 are not limited. The control circuit 7 controls the Y drive circuit 5 in accordance with detected temperature.

The X drive circuit 4 supplies a predetermined voltage to a plurality of X electrodes X1, X2, . . . , Xn. Hereinafter, each of the X electrodes X1, X2, . . . , Xn or the generic name of them will be called an X electrode Xi, and i means a subscript. The Y drive circuit 5 supplies a predetermined voltage to a plurality of scan electrodes (hereinafter called Y electrodes) Y1, Y2, . . . , and Yn. Hereinafter, each of the Y electrodes Y1, Y2, . . . and Yn or the generic name of them will be called a Y electrode Yi, and i means a subscript. The address drive circuit 6 supplies a predetermined voltage to a plurality of address electrodes A1, A2, . . . . Hereinafter, each of the address electrodes A1, A2, . . . or the generic name of them will be called an address electrode Aj, and j means a subscript.

In a plasma display panel 3, the Y electrodes Yi and the X electrodes Xi form the rows extending in parallel in the horizontal direction, and the address electrodes Aj form the columns extending in the vertical direction. The Y electrodes Yi and the X electrodes Xi are alternately disposed in the vertical direction. The Y electrode Yi and the address electrode Aj form the two-dimensional matrix in the row i and the column j. A display cell Cij is formed by an intersection point of the Y electrode Yi and the address electrode Aj, and the X electrode Xi which is correspondingly adjacent to it. The display cell cij corresponds to a pixel, and the panel 3 can display a two-dimensional image.

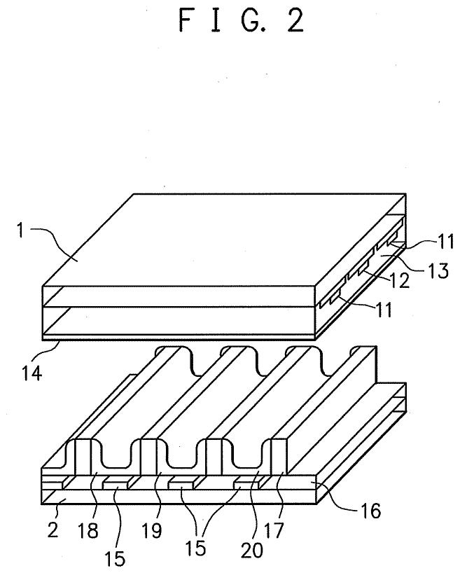

FIG. 2 is an exploded perspective view showing a structural example of the plasma display panel 3 according to the present embodiment. An X electrode 11 corresponds to the X electrode Xi in FIG. 1, a Y electrode 12 corresponds to the Y electrode Yi in FIG. 1, an address electrode 15 corresponds to the address electrode Aj in FIG. 1.

The X electrode 11 and the Y electrode 12 are formed on a front glass substrate 1. A dielectric layer 13 for insulating against a discharge space is applied onto it. Further, thereon, an MgO (magnesium oxide) protection layer 14 is applied. Meanwhile, the address electrode 15 is formed on a back glass substrate 2 disposed to be opposed to the front glass substrate 1. A dielectric layer 16 is applied thereon. Further, phosphors 18 to 20 are applied thereon. The phosphors 18 to 20 in red, blue and green are arranged by color and coated in a stripe shape on the inner surface of a rib (partition wall) 17. The phosphors 18 to 20 are excited by a discharge between the X electrode 11 and the Y electrode 12, and each color emits light. Ne+Xe penning gas or the like is sealed in a discharge space between the front glass substrate 1 and the back glass substrate 2.

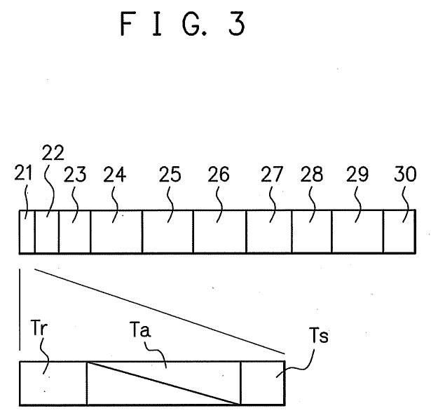

FIG. 3 is a conceptual diagram showing a configuration example of each field according to this embodiment. An image is formed at, for example, 60 fields/second. One field is formed by, for example, a first sub field 21, a second sub field 22, . . . , a tenth subfield 30. Each of the sub fields 21 to 30 are constructed by the reset period Tr, the address period Ta and the sustain (sustain discharge) period Ts.

In the reset period Tr, a predetermined voltage is applied to the X electrode Xi and the Y electrode Yi, and initialization of the display cell Cij is performed.

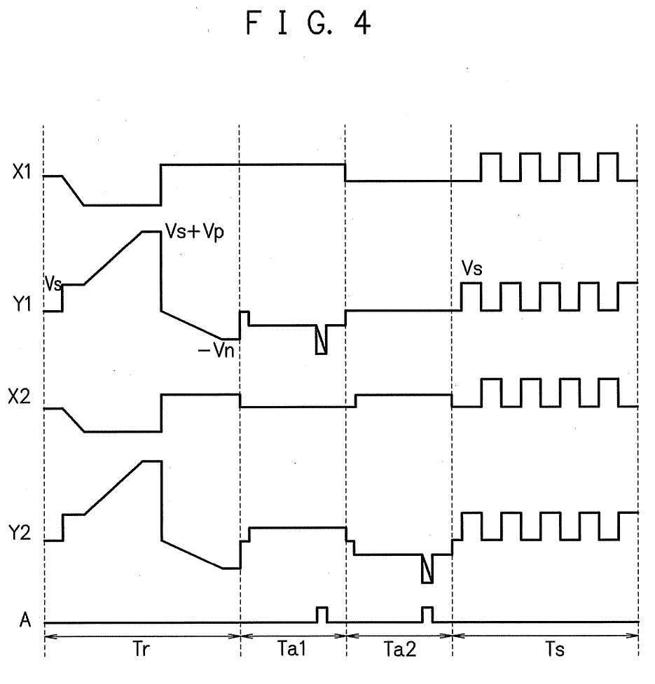

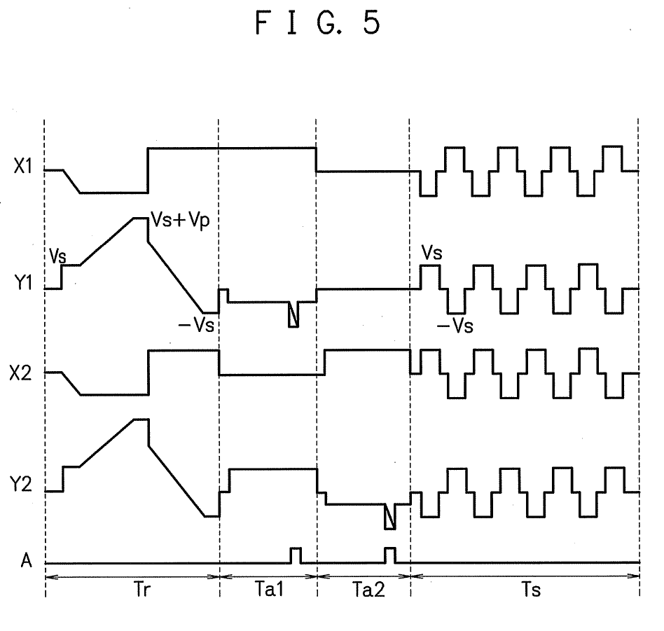

An address period Ta corresponds to address periods Ta1 and Ta2 in FIG. 4 and FIG. 5. In the address period Ta, a scan pulse is sequentially scanned and applied to the Y electrodes Y1, Y2, . . . , and Yn, and an address pulse is applied to the address electrode Aj corresponding to the scan pulse, whereby emission of the display cell Cij is selected. When the address pulse of the address electrode Aj is generated corresponding to the scan pulse of the Y electrode Yi, the emission of the display cell Cij of the Y electrode Yi and the X electrode Xi is selected. If the address pulse of the address electrode Aj is not generated corresponding to the scan pulse of the Y electrode Yi, the emission of the display cell Cij of the Y electrode Yi and the X electrode Xi is not selected, and non-emission is selected. When the address pulse is generated corresponding to the scan pulse, an address discharge between the address electrode Aj and the Y electrode Yi is generated. With this as a pilot flame, a discharge between the X electrode Xi and the Y electrode Yi is generated, negative charges are accumulated on the X electrode X1, and positive charges are accumulated on the Y electrode Yi.

In the sustain period Ts, sustain pulses of opposite phases from each other are applied between the X electrode Xi and the Y electrode Yi, and a sustain discharge is performed between the X electrode Xi and the Y electrode Yi of the selected display cell, and light emission is performed. In each of sub fields 21 to 30 in FIG. 3, the number of light emissions corresponding to the number of sustain pulses (length of the sustain period Ts) between the X electrode Xi and the Y electrode Yi differs. Thereby, a tone value can be determined.

As shown in FIGS. 1 and 2, the present embodiment can be applied to an ALIS type plasma display device. A plurality of X electrodes and a plurality of Y electrodes can be alternately disposed. In the ALIS type, the Y electrode can perform a sustain discharge between the Y electrode and the adjacent X electrodes on both sides of the Y electrode. For example, the Y electrode Y1 can construct the first display cell with the adjacent X electrode X1 on one side, and can construct the second display cell with the adjacent X electrode X2 on the other side. The first display cell performs a sustain discharge between the X electrode X1 and the Y electrode Y1. The second display cell performs a sustain discharge between the Y electrode Y1 and the X electrode X2.

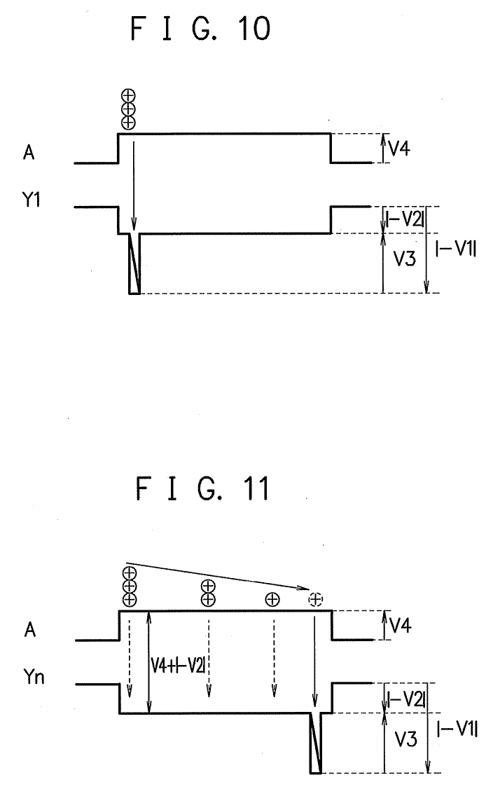

As described with reference to FIGS. 10 and 11 in the above description, there is no problem if the voltages of the Y electrodes Y1 to Yn as shown in FIGS. 10 and 11 are applied at a time of low temperature. However, at a time of high temperature, the above described problem occurs with the voltages of the Y electrodes 1 to Yn as shown in FIGS. 10 and 11.

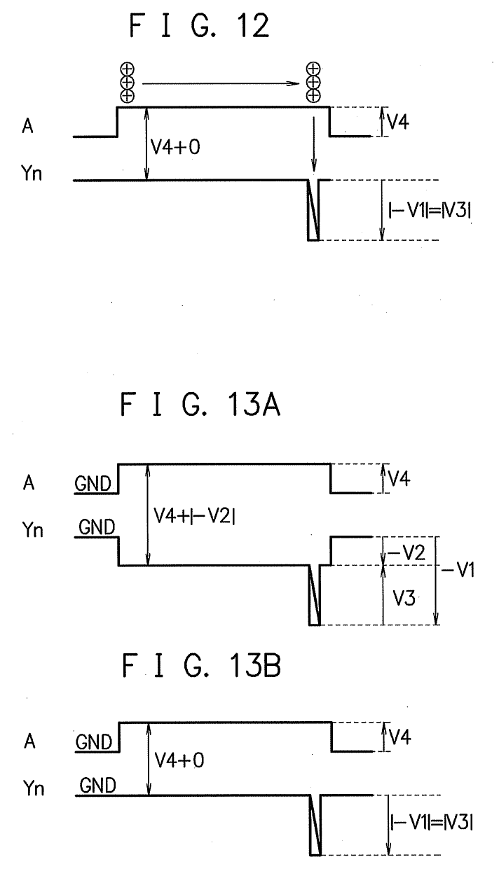

FIG. 12 is a diagram showing a voltage waveform of the Y electrode Yn in the final line and the address electrode A at the time of high temperature in the address period Ta according to the present embodiment. The scan pulse with the scan voltage −Vl being −V3 is sequentially applied to the Y electrodes Y1, Y2, . . . , and Yn. A two-dimensional image is constructed by a plurality of lines. The Y electrode Y1 is the Y electrode in the first (uppermost) line, and the scan pulse is applied to it first. The Y electrode Yn is the Y electrode in the final (lowermost) line, and the scan pulse is applied to it at last. In the address period Ta, at the Y electrode Yn, the scan voltage −V1 is the voltage −V3 at the time of applying the scan pulse, and the non-scan voltage is 0 V when the scan pulse is not applied.

When the scan pulse is applied to the Y electrode Yn, if the address pulse at the address voltage V4 is applied to the address electrode A, a discharge can be generated between the Y electrode Yn and the address electrode A. Here, the address voltage V4 is always applied to the address electrode A during the address period Ta, so that discharges are generated between the address electrode A and all the Y electrodes Y1 to Yn. For example, this is the case where all the pixels in the vertical direction are displayed.

There is the feature in the point that the non-scan voltage is at 0 V at the time of high temperature. Since the non-scan voltage is 0 V, the potential difference between the address electrode A and the Y electrode Yn at this time is V4+0, and is low. In the reset period Tr before the address period Ta, positive charges are formed on the address electrode A by the reset pulse. The low voltage V4 is applied between the Y electrode Yn and the address electrode A until the scan pulse is applied to the Y electrode Yn, and therefore, the positive charges on the address electrode A do not discharge and are kept. Even when the scan pulse is applied to the Y electrode Yn in the final line, the positive charges on the address electrode A do not decrease, and the Y electrode Yn can perform a stable address discharge between itself and the address electrode A by the scan pulse.

Since at the time of high temperature, an address discharge between the address electrode A and the Y electrode Y is easily performed, the absolute value of the scan voltage −V1 does not need to be made so large as at the time of low temperature, and |−V3| is sufficient. On the other hand, an address discharge is difficult to perform at the time of low temperature, and therefore, the absolute value of the scan voltage −V1 needs to be made large as shown in FIGS. 10 and 11, and is |−V2−V3|.

When the negative non-scan voltage is low at the high temperature time, the mis-address as shown in FIG. 11 occurs even if the absolute value of the scan voltage −V1 is large. Thus, the temperature detecting part 40 in FIG. 1 detects the temperature of the panel 3 and the ambient temperature. At the time of high temperature, the voltage (non-scan voltage is 0 V) of the Y electrode in FIG. 12 is generated, and at the time of low temperature, the voltage (non-scan voltage is −V2) of the Y electrode in FIGS. 10 and 11 is generated. Thereby, a stable address discharge without being influenced by temperature can be performed.

The amplitude voltage V3 of t he scan pulse is constant irrespective of temperature. Thereby, the Y drive circuit only has to include the withstand voltage against voltage V3, and the cost can be reduced by reducing the withstand voltage. At the time of low temperature, a discharge is hard to generate, and therefore, if the voltage in FIG. 12 is supplied at the time of low temperature, a sufficient address discharge cannot be generated with the potential difference V4+V3 between the address electrode A and the Y electrode Yn. Therefore, the voltage needs to be changed in accordance with temperature.

FIG. 13A is a diagram showing a voltage waveform of the Y electrode Yn in the final line and the address electrode A at the time of low temperature in the address period Ta according to the present embodiment. At the time of low temperature, which is, for example, 0 degrees, the voltage in FIG. 13A is generated. This voltage is the same as the voltages in FIGS. 10 and 11.

FIG. 13B is a diagram showing a voltage waveform of the Y electrode Yn in the final line and the address electrode A at the time of high temperature in the address period Ta according to the present embodiment. At the time of high temperature, which is, for example, 50 degrees, the voltage in FIG. 13B is generated. This voltage is the same as the voltage in FIG. 12.

The control circuit 7 detects temperature by the temperature detecting part 40. The Y drive circuit 5 supplies a voltage to the Y electrode in accordance with the detected temperature under the control of the control circuit 7. Specifically, the Y drive circuit 5 changes the voltage of the Y electrode at the time of not applying the scan pulse in the address period Ta in accordance with the detected temperature without changing the amplitude of the scan pulse.

The voltage of the Y electrode at the time of not applying the scan pulse in the address period Ta will be called a non-scan voltage hereinafter. The scan pulse is formed by the scan voltage −V1. The non-scan voltage is high voltage 0 V as shown in FIG. 13B when the detected temperature is higher than a predetermined value, and is the low negative voltage −V2 as shown in FIG. 13A when the temperature is lower than the predetermined value. The non-scan voltage preferably changes in the range from −30 V to 0 V inclusive.

Though only the voltage of the Y electrode Yn is shown, the voltages of the other Y electrodes Y1 to Yn-1 differ from the Y electrode Yn in only the temporal position of the scan pulse, and the other parts are the same as described above with reference with FIGS. 10 and 11.

### Second Embodiment

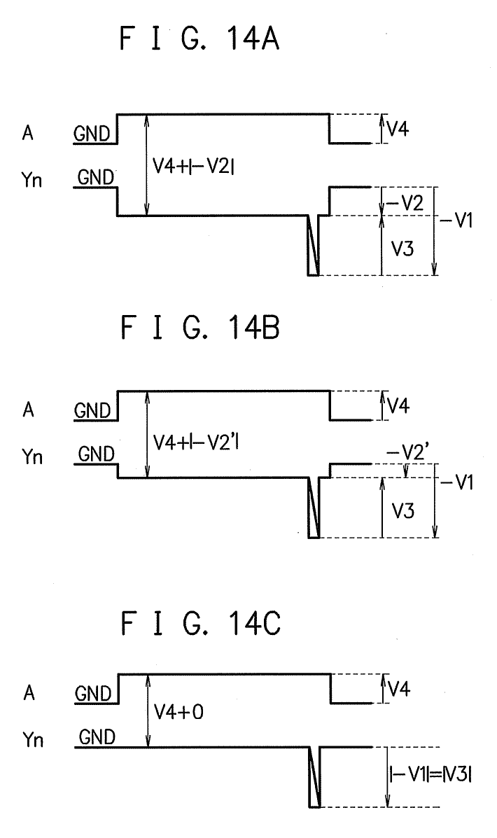

FIG. 14A is a diagram showing a voltage waveform of the Y electrode Yn in the final line and the address electrode A at the time of low temperature in the address period Ta according to a second embodiment. At the time of low temperature, which is for example, 0 degrees, the voltage in FIG. 14A is generated. This voltage is the same as the voltage in FIG. 13A.

FIG. 14C is a diagram showing a voltage waveform of the Y electrode Yn in the final line and the address electrode A at the time of high temperature in the address period Ta according to the present embodiment. At the time of high temperature, which is, for example, 50 degrees, the voltage in FIG. 14C is generated. This voltage is the same as the voltage in FIG. 13B.

FIG. 14B is a diagram showing a voltage waveform of the Y electrode Yn in the final line and the address electrode A at a time of intermediate temperature (room temperature) in the address period Ta according to the present embodiment. At the time of intermediate temperature, which is, for example, 25 degrees, the voltage in FIG. 14B is generated. The non-scan voltage is −V2′, and the other things are the same as those in FIGS. 14A and 14C. Namely, FIGS. 14A to 14C differ in the non-scan voltage and are the same in the other points.

The non-scan voltage −V2′ is lower than 0 V, and higher than −V2. The non-scan voltage may be continuously changed to be higher as the detected temperature becomes higher, or it may be changed stepwise to be higher as the detected temperature becomes higher.

### Third Embodiment

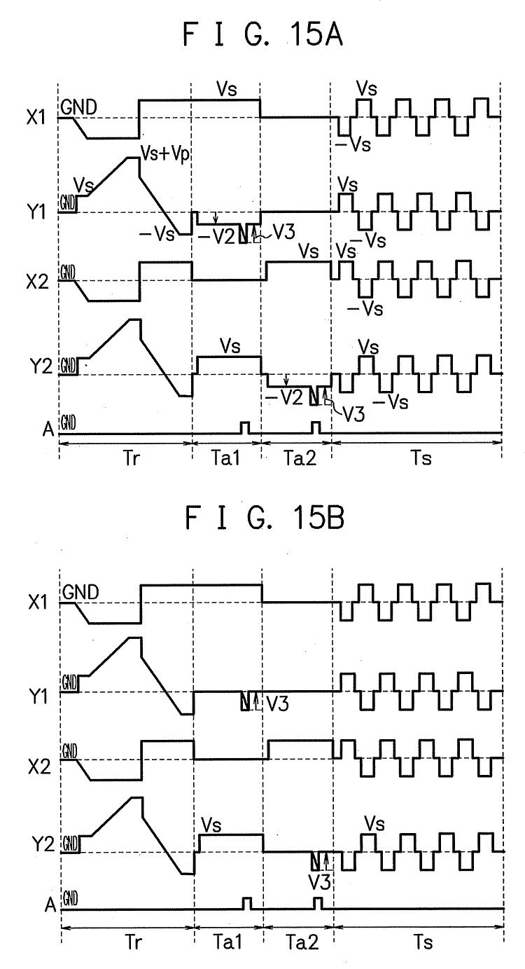

FIG. 15A is a diagram showing voltage waveform examples of the X electrodes X1 and X2, the Y electrodes Y1 and Y2 and the address electrode A in one field at the time of low temperature according to a third embodiment of the present invention. Only the point different from the above described FIG. 5 will be described hereinafter.

The address periods Ta1 and Ta2 correspond to the address period Ta in FIG. 3. In the first half address period Ta1, to perform address selection of the odd-numbered Y electrodes Y1, Y3 and the like, a scan pulse is sequentially applied to the odd-numbered Y electrodes Y1, Y3 and the like, and the scan pulse is not applied to the even-numbered Y electrodes Y2, Y4 and the like. In the odd-numbered Y electrodes Y1, Y3 and the like, the non-scan voltage is −V2, and the scan voltage is −V2−V3. When a positive address pulse is applied to the address electrode A corresponding to the negative scan pulse of the Y electrode Y1, an address discharge is generated between the Y electrode Y1 and the address electrode A. Since the X electrode X1 is at the positive sustain voltage Vs, a discharge is generated between the Y electrode Y1 and the X electrode X1 with the above described address discharge as the pilot flame, and wall charges are formed on the Y electrode Y1 and the X electrode X1. On this occasion, the X electrode X2 is at 0 V, and therefore, a discharge is not generated between the Y electrode Y1 and the X electrode X2. The voltages of the even-numbered Y electrodes Y2, Y4 and the like are the sustain voltages Vs. Thereby, the positive charges formed on the address electrode A are prevented from discharging to the even-numbered Y electrodes Y2, Y4 and the like, and address selection in the later second half address period Ta2 is made possible.

In the second half address period Ta2, to perform address selection of the even-numbered Y electrodes Y2, Y4 and the like, a scan pulse is sequentially applied to the even-numbered Y electrodes Y2, Y4 and the like, and the scan pulse is not applied to the odd-numbered Y electrodes Y1, Y3 and the like. In the even-numbered Y electrodes Y2, Y4 and the like, the non-scan voltage is −V2, and the scan voltage is −V2−V3. When the positive address pulse is applied to the address electrode A corresponding to the negative scan pulse of the Y electrode Y2, an address discharge is generated between the Y electrode Y2 and the address electrode A. Since the X electrode X2 is at the positive sustain voltage Vs, a discharge is generated between the Y electrode Y2 and the x electrode X2 with the above described address discharge as the pilot flame, and wall charges are formed on the Y electrode Y2 and the X electrode X2. On this occasion, the X electrode X3 is at 0 V, and therefore, a discharge is not generated between the Y electrode Y2 and the X electrode X3. The voltages of the odd-numbered Y electrodes Y1, Y3 and the like are 0 V. Since address selection is already finished in the first half address period Ta in the odd-numbered Y electrodes Y1, Y3 and the like, it is not necessary to prevent the positive charges on the address electrode A from discharging to the odd-numbered Y electrodes Y1, Y3 and the like, and the odd-numbered Y electrodes Y1, Y3 and the like can be made to be at In the sustain period Ts, a sustain pulse is applied to the X electrode and the Y electrode. The sustain pulse is the pulse with the positive sustain voltage Vs and the negative sustain voltage −Vs alternately reversed. The phase of the voltages of the odd-numbered Y electrodes Y1, Y3 and the like is opposite from the phase of the voltages of the even-numbered Y electrodes Y2, Y4 and the like. The phase of the voltages of the odd-numbered X electrodes X1, X3 and the like is opposite from the phase of the voltages of the odd-numbered Y electrodes Y1, Y3 and the like, and each time the sustain pulse is applied, a discharge is performed between the address-selected X electrode X1 and Y electrode Y1 to emit light. The voltages of the even-numbered X electrodes X2, X4 and the like is of the opposite phase from that of the voltages of the even-numbered Y electrodes Y2, Y4 and the like, and each time a sustain pulse is applied, a discharge is performed between the address-selected X electrode X2 and Y electrode Y2 to emit light.

FIG. 15B is a diagram showing voltage waveform examples of the X electrodes X1 and X2, the Y electrodes Y1 and Y2 and the address electrode A in one field at the time of high temperature according to the present embodiment. Only the point different from the above described FIG. 15A will be described hereinafter. FIG. 15B differs in the point that the non-scan voltages of all the Y electrodes Y1, Y2 and the like are 0 V, in the address periods Ta1 and Ta2.

As described above, in the present embodiment, as the first embodiment, the non-scan voltage at the time of low temperature (FIG. 15A) is −V2, and the non-scan voltage at the time of high temperature (FIG. 15B) is 0 V. The non-scan voltage changes in accordance with temperature.

In the first half address period Ta1, the voltages of the odd-numbered Y electrodes Y1, Y3 and the like at a time of not applying the scan pulse change in accordance with the detected temperature, and the voltages of the even-numbered Y electrodes Y2, Y4 and the like become not less than the voltages (non-scan voltages) of the odd-numbered Y electrodes Y1, Y3 and the like at the time of not applying the scan pulse. For example, the voltages of the even-numbered Y electrodes Y2, Y4 and the like at this time is from 0 V to the positive sustain voltage Vs inclusive.

In the second half address period Ta2, the voltages of the even-numbered Y electrodes Y2, Y4 and the like at the time of not applying the scan pulse changes in accordance with the detected temperature, and the voltages of the odd-numbered Y electrodes Y1, Y3 and the like become not less than the voltages (non-scan voltages) of the even-numbered Y electrodes Y2, Y4 and the like at the time of not applying the scan pulse. For example, the voltages of the odd-numbered Y electrodes Y1, Y3 and the like at this time become 0 V.

### Fourth Embodiment

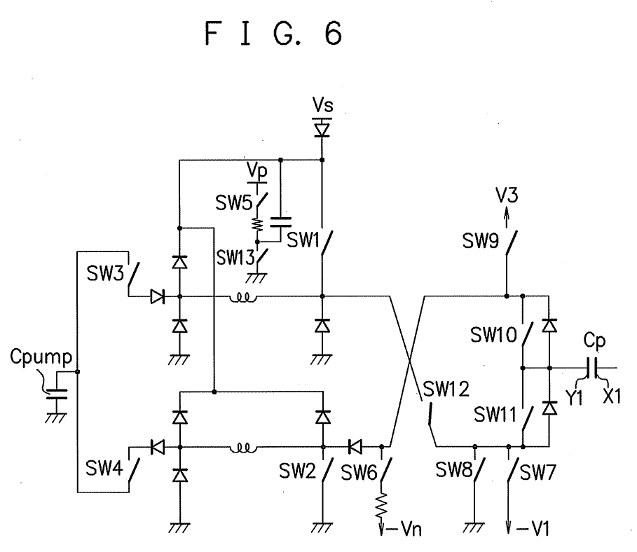

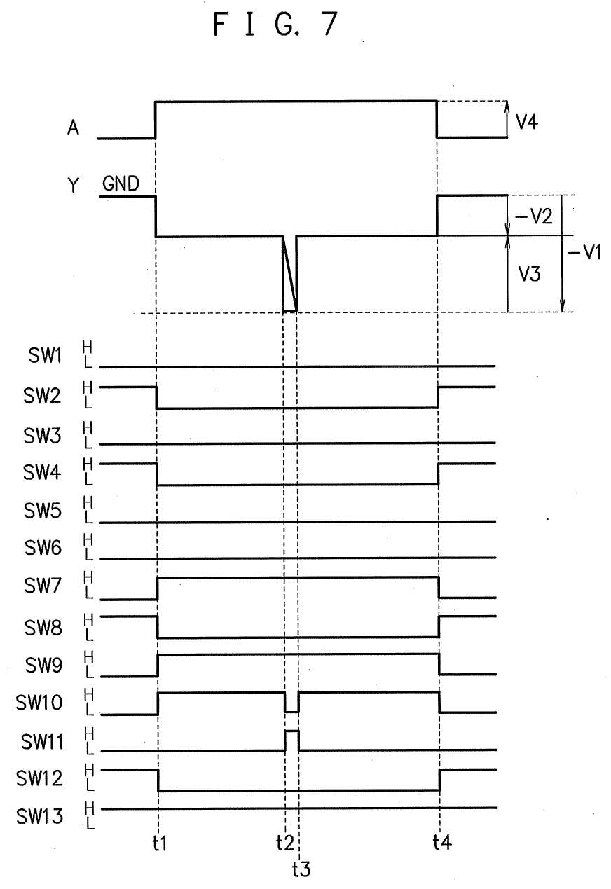

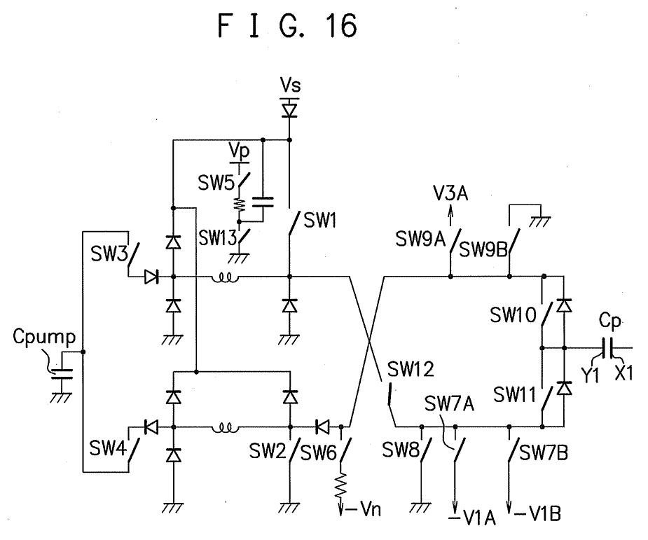

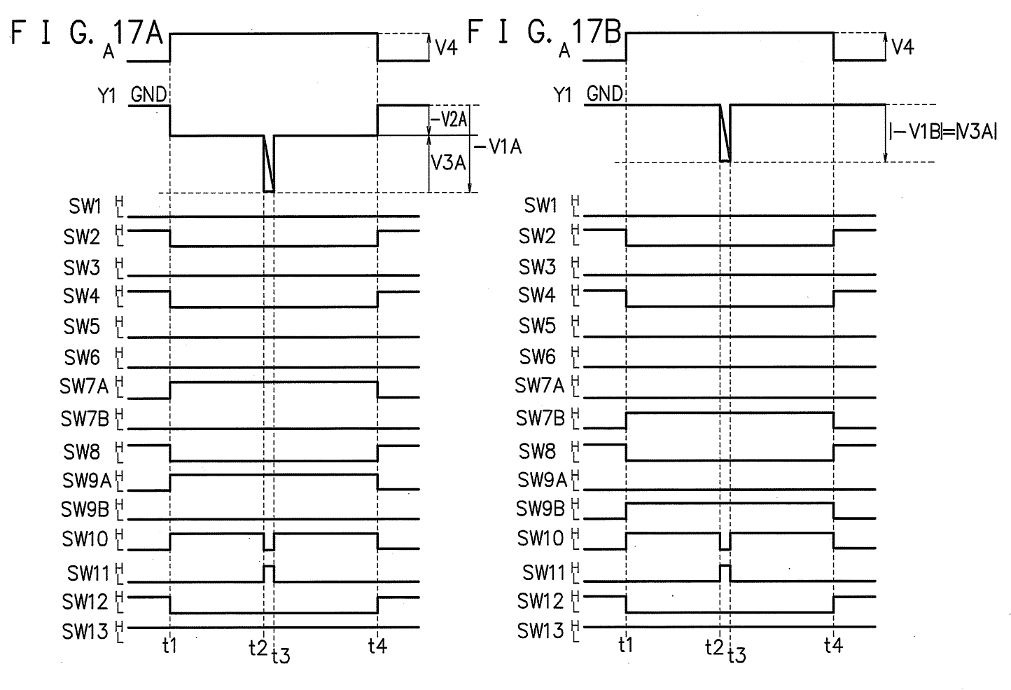

FIG. 16 is a circuit diagram showing a configuration example of a Y drive circuit 5 (FIG. 1) according to a fourth embodiment of the present invention. The Y drive circuit corresponds to FIG. 6, and generates the voltage of the Y electrode Y1 in FIG. 4. However, in the address periods Ta1 and Ta2 in FIG. 4, it generates the voltage in FIG. 17A or 17B in accordance with temperature. The circuits which generate the voltages of the other Y electrodes also have the same configuration. The panel capacitance Cp is constructed by, for example, the X electrode X1 and the Y electrode Y1. In FIG. 4, in the reset period Tr, reset of the display cell is performed by the reset pulse. The voltage of the Y electrode Y1 is generated by the voltages Vs, Vp and −Vn. In the first half address period Ta1, address selection of the odd-numbered Y electrode Y1 is performed. In the second half address period Ta2, address selection of the even-numbered Y electrode Y2 is performed. The details of the address periods Ta1 and Ta2 will be described with reference to FIGS. 17A and 17B later. In FIG. 4, in the sustain period Ts, a sustain pulse is applied to the Y electrode Y1. The sustain pulse is generated by the positive sustain voltage Vs and the ground GND. A sustain discharge can be performed between the X electrode X1 and the Y electrode Y1 by this sustain pulse.

FIG. 17A is a timing chart showing an operation example of the circuit in FIG. 16 at the time of low temperature in the address periods Ta1 and Ta2. The address pulse at the voltage V4 is applied to the address electrode A at the timings t1 to t4. Hereinafter, the voltage of the Y electrode Y1 will be described as an example, but the voltages of the other Y electrodes are the same.

Before the timing t1, switches SW1, SW3, SW5, SW6, SW7A, SW7B, SW9A, SW9B, SW10 and SW11 are turned off, and switches SW2, SW4, SW8, SW12 and SW13 are turned on. Then, the Y electrode Y1 is at 0 V.

Next, at the timing t1, the switches SW2, SW4, SW8 and SW12 are turned off, and the switches SW7A, SW9A and SW10 are turned on. Then, the Y electrode Y1 is at the non-scan voltage −V2A. The non-scan voltage −V2A is expressed by −V1A+V3A.

Next, at the timing t2, the switch SW10 is turned off, and the switch SW11 is turned on. Then, the Y electrode Y1 is at the scan electrode −V1A. The amplitude of this scan pulse is V1A−V2A=V3A.

Next, at the timing t3, the switch SW10 is turned on, and the switch SW11 is turned off. Then, the Y electrode Y1 is at the non-scan voltage −V2A.

Next, at the timing t4, the switches SW2, SW4, SW8 and SW12 are turned on, and the switches SW7A, SW9A and SW10 are turned off. Then, the Y electrode Y1 is at 0 V.

FIG. 17B is a timing chart showing an operation example of the circuit in FIG. 16 at the time of high temperature in the address periods Ta1 and Ta2. An address pulse at the voltage V4 is applied to the address electrode A at the timings t1 to t4. Hereinafter, the voltage of the Y electrode Y1 will be described as an example, but the voltages of the other Y electrodes are the same. The voltage before the timing t1 and at the timing t4 and thereafter is the same as in FIG. 17A. The timings t1, t2 and t3 will be described hereinafter.

At the timing t1, the switches SW2, SW4, SW8 and SW12 are turned off, and the switches SW7B, SW9B and the SW10 are turned on. Then, the Y electrode Y1 is at 0 V.

Next, at the timing t2, the switch SW10 is turned off, and the switch SW11 is turned on. Then, the Y electrode Y1 is at a voltage −V1B. The absolute value of the voltage −V1B is the same as a voltage V3A. Accordingly, the amplitude voltages of the scan pulses in FIGS. 17A and 17B are the same.

Next, at the timing t3, the switch SW10 is turned on, and the switch SW11 is turned off. Then, the Y electrode Y1 is at 0 V.

As described above, the voltage of the non-scan voltage of −V2A is generated as shown in FIG. 17A at the time of low temperature, and the voltage of the non-scan voltage of 0 V is generated as shown in FIG. 17B at the time of high temperature. The amplitude voltage of the scan pulse is the same at the time of low temperature and high temperature.

### Fifth Embodiment

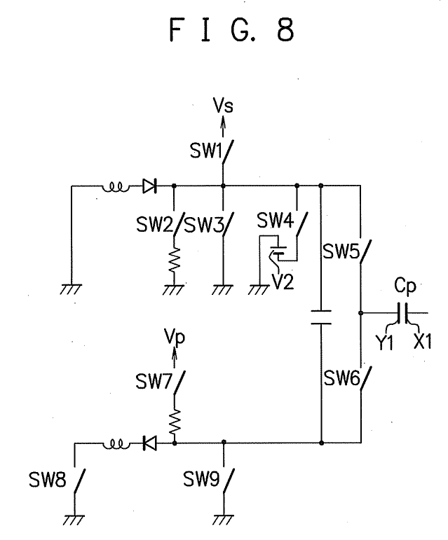

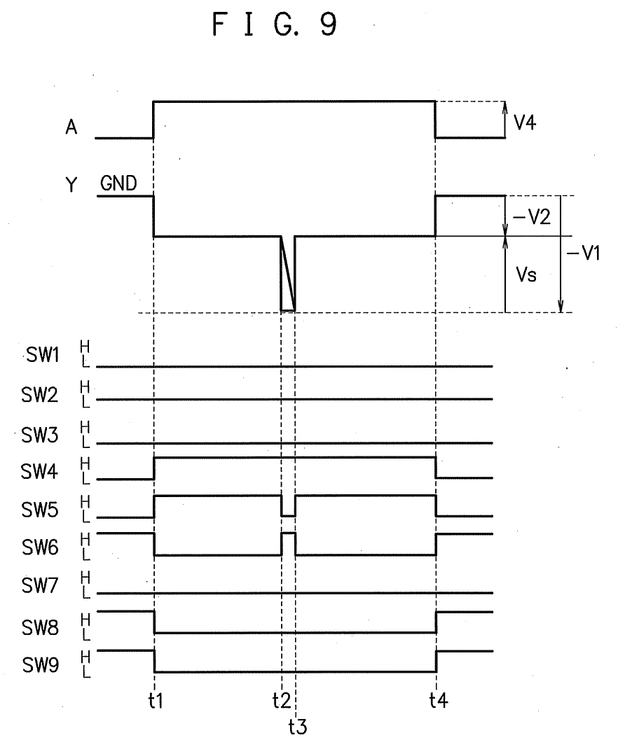

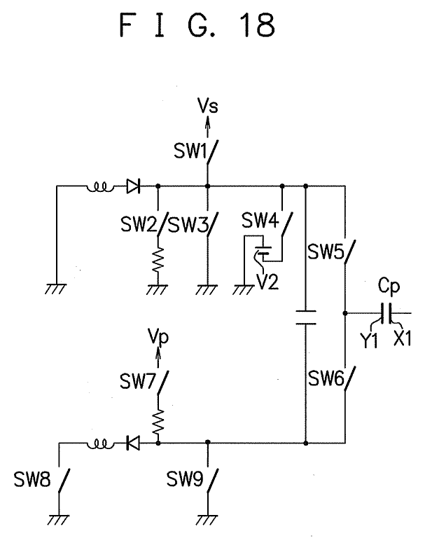

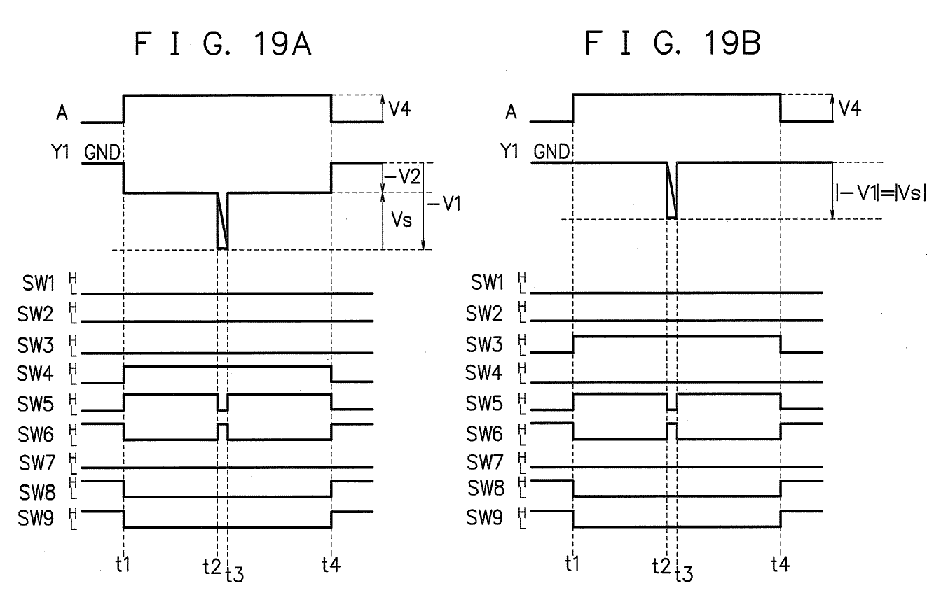

FIG. 18 is a circuit diagram showing a configuration example of the Y drive circuit 5 (FIG. 1) according to a fifth embodiment of the present invention. The Y drive circuit corresponds to FIG. 8 and generates the voltage of the Y electrode Y1 in FIG. 5. However, in the address periods Ta1 and Ta2 in FIG. 5, the Y drive circuit generates the voltage in FIG. 19A or 19B in accordance with temperature. The circuits which generate the voltages of the other Y electrodes have the same configuration. The panel capacitance Cp is constructed by, for example, the X electrode X1 and the Y electrode Y1. In FIG. 5, in the reset period Tr, reset of the display cell is performed by the reset pulse. The voltage of the Y electrode Y1 is generated by the voltages Vs, Vp and −Vs. In the first half address period Ta1, address selection of the odd-numbered Y electrode Y1 is performed. In the second half address period Ta2, address selection of the even-numbered Y electrode Y2 is performed. The details of the address periods Ta1 and Ta2 will be described with reference to FIGS. 19A and 19B later. In FIG. 5, in the sustain period Ts, a sustain pulse is applied to the Y electrode Y1. The sustain pulse is generated by the positive sustain voltage Vs and the negative sustain voltage −Vs. A sustain discharge can be performed between the X electrode X1 and the Y electrode Y1 by this sustain pulse.

In the sustain period Ts, the sustain pulse with the sustain voltages Vs and −Vs having positive and negative polarities alternately reversed is supplied to the Y electrode Y1. In order to supply the positive sustain voltage Vs to the Y electrode Y1, the switches SW1 and SW5 only have to be turned on. On this occasion, if the switch SW9 is turned on, the voltage Vs is charged in a capacitor. Thereafter, the switches SW1, SW5 and SW9 are turned off, and the switches SW3 and SW6 are turned on, whereby the negative sustain voltage −VS can be supplied to the Y electrode Y1.

FIG. 19A is a timing chart showing an operation example of the circuit in FIG. 18 at the time of low temperature in the address periods Ta1 and Ta2. The address pulse at the voltage V4 is applied to the address electrode A at the timings t1 to t4. Hereinafter, the voltage of the Y electrode Y1 will be described as an example, but the voltages of the other Y electrodes are the same.

Before the timing t1, the switches SW1, SW2, SW3, SW4, SW5 and SW7 are turned off, and the switches SW6, SW8 and SW9 are turned on. Then, the Y electrode Yl is at 0 V.

Next, at the timing t1, the switches SW4 and SW5 are turned on, and the switches SW6, SW8 and SW9 are turned off. Then, the Y electrode Y1 is at the non-scan voltage −V2.

Next, at the timing t2, the switch SW5 is turned off, and the switch SW6 is turned on. Then, the Y electrode Y1 is at the scan electrode −V1. The scan voltage −V1 is expressed by −V2−Vs. The amplitude of this scan pulse is the voltage Vs.

Next, at the timing t3, the switch SW5 is turned on, and the switch SW6 is turned off. Then, the Y electrode Y1 is at the non-scan voltage −V2.

Next, at the timing t4, the switches SW4 and SW5 are turned off, and the switches SW6, SW8 and SW9 are turned off. Then, the Y electrode Y1 is at 0 V.

FIG. 19B is a timing chart showing an operation example of the circuit in FIG. 18 at the time of high temperature in the address periods Ta1 and Ta2. An address pulse at the voltage V4 is applied to the address electrode A at the timings t1 o t4. Hereinafter, the voltage of the Y electrode Y1 will be described as an example, but the voltages of the other Y electrodes are the same. The voltage before the timing t1 and at the timing t4 and thereafter is the same as in FIG. 19A. The timings t1, t2 and t3 will be described hereinafter.

At the timing t1, the switches SW3 and SW5 are turned on, and the switches SW6, SW8 and the SW9 are turned off. Then, the Y electrode Y1 is at 0 V.

Next, at the timing t2, the switch SW5 is turned off, and the switch SW6 is turned on. Then, the Y electrode Yi is at the voltage −Vs. Namely, the scan voltage −V1 becomes −Vs. The amplitude of this scan pulse is the voltage Vs, and is the same as 19A.

Next, at the timing t3, the switch SW 5 is turned on, and the switch SW6 is turned off. Then, the Y electrode Y1 is at 0 V.

As described above, the voltage of the non-scan voltage of −V2 is generated as shown in FIG. 19A at the time of low temperature, and the voltage of the non-scan voltage of 0 V is generated as shown in FIG. 19B at the time of high temperature. The amplitude voltage of the scan pulse is the same at the time of low temperature and high temperature.

### Sixth Embodiment

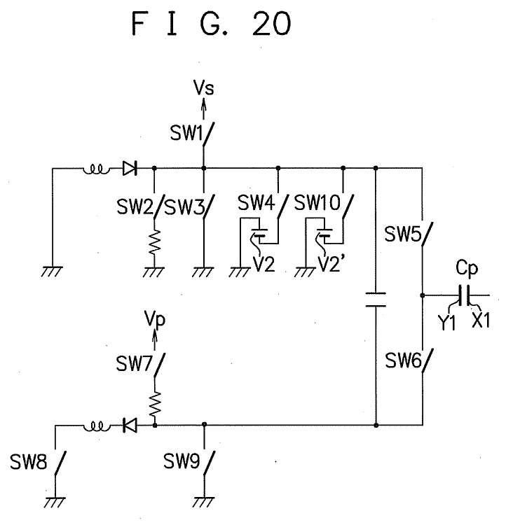

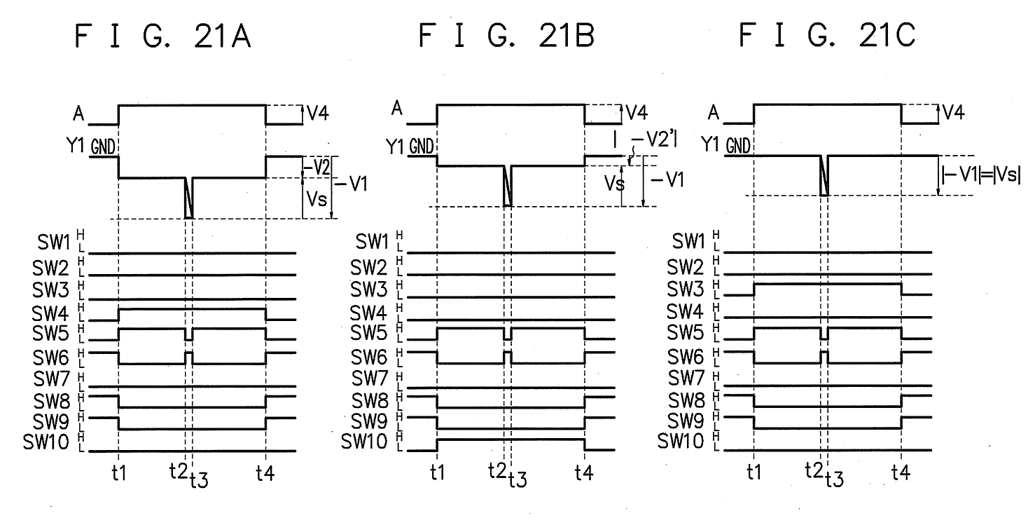

FIG. 20 is a circuit diagram showing a configuration example of the Y drive circuit 5 (FIG. 1) according to a sixth embodiment of the present invention. The Y drive circuit corresponds to FIG. 8 and generates the voltage of the Y electrode Y1 in FIG. 5. However, in the address periods Ta1 and Ta2 in FIG. 5, the Y drive circuit generates the voltage in FIGS. 21A to 21C in accordance with the temperature as in FIGS. 14A to 14. The circuits which generate the voltages of the other Y electrodes have the same configuration. Hereinafter, the point in which the present embodiment differs from the fifth embodiment will be described. In the present embodiment, in the address periods Ta1 and Ta2, the Y drive circuit 5 generates the voltage in FIG. 21A at the time of low temperature, generates the voltage in FIG. 21B at the time of intermediate temperature, and generates the voltage in FIG. 21C at the time of high temperature.

FIG. 21A is a timing chart showing an operation example of the circuit in FIG. 20 at the time of low temperature in the address periods Ta1 and Ta2. The address pulse of the voltage V4 is applied to the address electrode A at the timings t1 to t4. Hereinafter, the voltage of the Y electrode Y1 will be described as an example, but the voltages of the other Y electrodes are the same.

Before the timing t1, the switches SW1, SW2, SW3, SW4, SW5, SW7 and SW10 are turned off, and the switches SW6, SW8 and SW9 are turned on. Then, the Y electrode Y1 is at 0 V.

Next, at the timing t1, the switches SW4 and SW5 are turned on, and the switches SW6, SW8 and SW9 are turned off. Then, the Y electrode Y1 is at the non-scan voltage −V2.

Next, at the timing t2, the switch SW5 is turned off, and the switch SW6 is turned on. Then, the Y electrode Y1 is at the scan voltage −V1. The scan voltage −V1 is expressed by −V2−Vs. The amplitude of this scan pulse is the voltage Vs.

Next, at the timing t3, the switch SW5 is turned on, and the switch SW6 is turned off. Then, the Y electrode Yi is at the non-scan voltage −V2.

Next, at the timing t4, the switches SW4 and SW5 are turned off, and the switches SW6, SW8 and SW9 are turned on. Then, the Y electrode Y1 is at 0V.

FIG. 21B is a timing chart showing an operation example of the circuit in FIG. 20 at the time of intermediate temperature in the address periods Ta1 and Ta2. An address pulse of the voltage V4 is applied to the address electrode A at the timings t1 o t4. Hereinafter, the voltage of the Y electrode Y1 will be described as an example, but the voltages of the other Y electrodes are the same. The voltage before the timing t1 and at the timing t4 and thereafter is the same as in FIG. 21A. The timings t1, t2 and t3 will be described hereinafter.

At the timing t1, the switches SW5 and SW10 are turned on, and the switches SW6, SW8 and SW9 are turned off. Then, the Y electrode Y1 is at the non-scan voltage −V2′.

Next, at the timing t2, the switch SW5 is turned off, and the switch SW6 is turned on. Then, the Y electrode Y1 is at the scan voltage −V1. The scan voltage −V1 is expressed by −V2′−Vs. The amplitude of this scan pulse is the voltage V1−V2′=Vs, and is the same as FIG. 21A.

Next, at the timing t3, the switch SW5 is turned on, and the switch SW6 is turned off. Then, the Y electrode Y1 is at the non-scan voltage −V2′.

FIG. 21C is a timing chart showing an operation example of the circuit in FIG. 20 at the time of high temperature in the address periods Ta1 and Ta2. An address pulse of the voltage V4 is applied to the address electrode A at the timings t1 o t4. Hereinafter, the voltage of the Y electrode Y1 will be described as an example, but the voltages of the other Y electrodes are the same. The voltage before the timing t1 and at the timing t4 and thereafter is the same as in FIGS. 21A and 21B. The timings t1, t2 and t3 will be described hereinafter.

At the timing t1, the switches SW3 and SW5 are turned on, and the switches SW6, SW8 and SW9 are turned off. Then, the non-scan voltage of the Y electrode Y1 becomes 0 V.

Next, at the timing t2, the switch SW5 is turned off, and the switch SW6 is turned on. Then, the Y electrode Y1 is at the voltage −Vs. The scan voltage −V1 becomes −Vs. The amplitude of this scan pulse is the voltage Vs, and the same as in FIGS. 21A and 21B.

Next, at the timing t3, the switch SW5 is turned on, and the switch SW6 is turned off. Then, the non-scan voltage of the Y electrode Y1 is at 0 V.

As described above, the voltage with the non-scan voltage of −V2 is generated as shown in FIG. 21A at the time of low temperature, the voltage with the non-scan voltage of −V2′ is generated as shown in FIG. 21B at the time of intermediate temperature, and the voltage with the non-scan voltage of 0 V is generated as shown in FIG. 21C at the time of high temperature. The amplitude voltages of the all the scan pulses are the same at the time of low temperature, intermediate temperature and high temperature.

According to the above described first to sixth embodiment, the Y drive circuit changes the voltage of the Y electrode at the time of not applying the scan pulse in accordance with the detected temperature in the address periods Ta1 and Ta2 without changing the amplitude of the scan pulse.

In FIG. 11, the potential difference V4+V2 is always applied between the Y electrode Yn in the final line and the address electrode A until the scan pulse is applied to the Y electrode Yn in the final line. Therefore, especially at the time of high temperature, very small positive charge shift from the address electrode A to the Y electrode Yn occurs, and when the scan pulse is applied to the Y electrode Yn, the positive charges on the address electrode A which are required for a discharge between the address electrode A and the Y electrode Yn decrease, and a discharge cannot be generated between the address electrode A and the Y electrode Yn. In this situation, address selection is not performed, and the final line is not displayed.

In the present embodiment, the non-scan voltage is made high and the voltage between the Y electrode and the address electrode is made low at the time of high temperature. Thereby, the positive charges on the address electrode A do not decrease. Thus, when the scan pulse is applied to the Y electrode Yn in the final line, a stable address discharge is performed between the Y electrode Yn and the address electrode A when the address pulse is applied to the address electrode A, and proper display can be performed. On the other hand, a discharge is hard to generate at the time of low temperature. Therefore, the non-scan voltage and the scan voltage are made low, and the voltage between the Y electrode and the address electrode at the time of applying the scan pulse is made high. Thereby, when the scan pulse is applied to the Y electrode, a stable address discharge is performed between the Y electrode and the address electrode when the address pulse is applied to the address electrode, and proper display can be made, even at the time of low temperature. By making the amplitude voltage of the scan pulse constant irrespective of temperature, the withstand voltage of the Y drive circuit can be made constant irrespective of temperature, and therefore, the withstand voltage of it can be made low.

Since the voltage of the Y electrode is changed in accordance with the detected temperature, a discharge can be generated stably between the address electrode and the Y electrode without being influenced by the temperature in the address period. Thereby, when all the pixels in the vertical direction are displayed at the time of high temperature, the pixel in the lowermost portion can be displayed stably.

Since the voltage of the scan electrode is changed in accordance with the detected temperature, a discharge can be generated stably between the address electrode and the scan electrode without being influenced by the temperature in the address period. Thereby, when all the pixels in the vertical direction are displayed at the time of high temperature, the pixel in the lowermost portion can be displayed-stably.

The present embodiments are to be considered in all respects as illustrative and no restrictive, and all changes which come within the meaning and range of equivalency of the claims are therefore intended to be embraced therein. The invention may be embodied in other specific forms without departing from the spirit or essential characteristics thereof.

What is claimed is:

1. A plasma display device, comprising:
a temperature detecting part that detects temperature;
a scan electrode to which a scan pulse for selection is applied in an address period;
an address electrode to which an address pulse is applied corresponding to the scan pulse to select emission or non-emission of a display cell; and
a scan electrode drive circuit supplying a voltage to said scan electrode in accordance with the detected temperature,
wherein said scan electrode dive circuit changes a voltage of said scan electrode at a time of not applying the scan pulse in the address period in accordance with the detected temperature without changing an amplitude of the scan pulse.

2. The plasma display device according to claim 1,
wherein the voltage of said scan electrode at the time of not applying the scan pulse in the address period is higher when the detected temperature is higher than a predetermined value than when the detected temperature is lower than the predetermined value.

3. The plasma display device according to claim 2,
wherein the voltage of said scan electrode at the time of not applying the scan pulse in the address period changes continuously so as to be higher as the detected temperature becomes higher.

4. The plasma display device according to claim 2,
wherein the voltage of said scan electrode at the time of not applying the scan pulse in the address period changes stepwise so as to be higher as the detected temperature becomes higher.

5. The plasma display device according to claim 1,
wherein a plurality of said scan electrodes exist,
the address period has a first address period to apply a scan pulse sequentially to odd-numbered scan electrodes, and a second address period to apply the scan pulse sequentially to even-numbered scan electrodes,
in the first address period, voltages of the odd-numbered scan electrodes at the time of not applying the scan pulse change in accordance with the detected temperature, and voltages of the even-numbered scan electrodes become not less than the voltages of the odd-numbered scan electrodes at the time of not applying the scan pulse, and
in the second address period, the voltages of the even-numbered scan electrodes at the time of not applying the scan pulse change in accordance with the detected temperature, and the voltages of the odd-numbered scan electrodes become not less than the voltages of the even-numbered scan electrodes at the time of not applying the scan pulse.

6. The plasma display device according to claim 1,
wherein a plurality of said scan electrodes exist,
said plasma display device further comprising a plurality of X electrodes alternately disposed with respect to said plurality of scan electrodes,
wherein said scan electrode is capable of a sustain discharge between the scan electrode and adjacent X electrodes at both sides of it.

7. The plasma display device according to claim 1,
wherein said scan electrode drive circuit supplies a sustain pulse with sustain voltages of positive and negative polarities alternately reversed to said scan electrode in a sustain period after the address period.

8. The plasma display device according to claim 2,
wherein the voltage of said scan electrode at the time of not applying the scan pulse in the address period is 0 V when the detected temperature is higher than the predetermined value, and is a negative voltage when it is lower than the predetermined value.

9. The plasma display device according to claim 8,
wherein the voltage of said scan electrode at the time of not applying the scan pulse in the address period is not less than −30 V.

10. The plasma display device according to claim 7,
wherein the address period has a first address period to apply a scan pulse sequentially to odd-numbered scan electrodes, and thereafter, a second address period to apply the scan pulse sequentially to even-numbered scan electrodes,
in the first address period, voltages of the odd-numbered scan electrodes at the time of not applying the scan pulse change in accordance with the detected temperature, and voltages of the even-numbered scan electrodes become not less than 0 V and not more than the positive sustain voltage, and
in the second address period, the voltages of the even-numbered scan electrodes at the time of not applying the scan pulse change in accordance with the detected temperature, and the voltages of the odd-numbered scan electrodes become 0 v.

11. A method for driving a plasma display device having a scan electrode to which a scan pulse for selection is applied in an address period, and an address electrode to which an address pulse is applied corresponding to the scan pulse to select emission or non-emission of a display cell, comprising:
a temperature detecting step of detecting temperature; and
a first scan electrode voltage generating step of changing a voltage of said scan electrode at a time of not applying the scan pulse in the address period in accordance with the detected temperature without changing an amplitude of the scan pulse.

12. The method for driving a plasma display device according to claim 11,
wherein the voltage of said scan electrode at the time of not applying the scan pulse in the address period is higher when the detected temperature is higher than a predetermined value than when the detected temperature is lower than the predetermined value.

13. The method for driving a plasma display device according to claim 12,
wherein the voltage of said scan electrode at the time of not applying the scan pulse in the address period changes continuously so as to be higher as the detected temperature becomes higher.

14. The method for driving a plasma display device according to claim 12,
wherein the voltage of said scan electrode at the time of not applying the scan pulse in the address period changes stepwise so as to be higher as the detected temperature becomes higher.

15. The method for driving a plasma display device according to claim 11,
wherein a plurality of said scan electrodes exist,
the address period has a first address period to apply a scan pulse sequentially to odd-numbered scan electrodes, and a second address period to apply the scan pulse sequentially to even-numbered scan electrodes,
in the first address period, voltages of the odd-numbered scan electrodes at the time of not applying the scan pulse change in accordance with the detected temperature, and voltages of the even-numbered scan electrodes become not less than the voltages of the odd-numbered scan electrodes at the time of not applying the scan pulse, and
in the second address period, the voltages of the even-numbered scan electrodes at the time of not applying the scan pulse change in accordance with the detected temperature, and the voltages of the odd-numbered scan electrodes become not less than the voltages of the even-numbered scan electrodes at the time of not applying the scan pulse.

16. The method for driving a plasma display device according to claim 11,
wherein a plurality of said scan electrodes exist,
said plasma display device further comprises a plurality of X electrodes alternately disposed with respect to said plurality of scan electrodes, and
said scan electrode is capable of a sustain discharge between the scan electrode and adjacent X electrodes at both sides of it.

17. The method for driving a plasma display device according to claim 11, further comprising:
a second scan electrode voltage generating step of supplying a sustain pulse with sustain voltages of positive and negative polarities alternately reversed to said scan electrode in a sustain period after the address period.

18. The method for driving a plasma display device according to claim 12,
wherein the voltage of said scan electrode at the time of not applying the scan pulse in the address period is 0 V when the detected temperature is higher the predetermined value, and is a negative voltage when it is lower than the predetermined value.

19. The method for driving a plasma display device according to claim 18,
wherein the voltage of said scan electrode at the time of not applying the scan pulse in the address period is not less than -30 V.

20. The method for driving a plasma display device according to claim 17,
wherein the address period has a first address period to apply a scan pulse sequentially to odd-numbered scan electrodes, and thereafter, a second address period to apply the scan pulse sequentially to even-numbered scan electrodes,
in the first address period, voltages of the odd-numbered scan electrodes at the time of not applying the scan pulse change in accordance with the detected temperature, and voltages of the even-numbered scan electrodes become not less than 0 V and not more than the positive sustain voltage, and
in the second address period, the voltages of the even-numbered scan electrodes at the time of not applying the scan pulse change in accordance with the detected temperature, and the voltages of the odd-numbered scan electrodes become 0 V.
